(19) United States
(12) Patent Application Publication
(10) Pub. No.: US 2025/0273711 A1
(43) Pub. Date: Aug. 28, 2025

(54) STARTUP CONTROL METHOD AND APPARATUS FOR FUEL CELL SYSTEM, ELECTRONIC DEVICE, AND MEDIUM

(71) Applicant: GUANGDONG YUNTAO HYDROGEN ENERGY TECHNOLOGY CO.,LTD., Guangzhou (CN)

(72) Inventors: Bin CHI, Guangzhou (CN); Jiajun LI, Guangzhou (CN); Qiang YANG, Guangzhou (CN)

(21) Appl. No.: 19/208,566

(22) Filed: May 14, 2025

Related U.S. Application Data
(63) Continuation of application No. PCT/CN2024/107463, filed on Jul. 25, 2024.

(30) Foreign Application Priority Data
Dec. 1, 2023 (CN) 202311628180.3

(51) Int. Cl. H01M 8/04537; H01M 8/04302; H01M 8/0438; H01M 8/04746; H01M 8/04858

(52) U.S. Cl. CPC H01M 8/04559; H01M 8/04302; H01M 8/04388; H01M 8/04753; H01M 8/0491

(57) ABSTRACT

The present application relates to a startup control method and apparatus for a fuel cell system, an electronic device, and a medium, applied to the technical field of fuel cells. The method includes: setting a loading current as a first current value, in response to a monolithic voltage value of a stack being smaller than the first voltage value, decreasing the loading current; in response to the decreased loading current being larger than a second current value and the monolithic voltage value being larger than or equal to the first voltage value, running the fuel cell system for a period of time under the loading current, and then returning for setting the loading current as the first current value.

### CROSS-REFERENCE TO RELATED APPLICATIONS

This application is a continuation of International Patent Application No. PCT/CN2024/107463, filed on Jul. 25, 2024, which claims the benefit of priority from Chinese Patent Application No. 202311628180.3, filed on Dec. 1, 2023. The content of the aforementioned applications, including any intervening amendments thereto, are incorporated herein by reference.

### TECHNICAL FIELD

The present application relates to the technical field of fuel cells, and in particular, to a startup control method and apparatus for a fuel cell system, an electronic device, and a medium.

### BACKGROUND

A fuel cell system is composed of a stack, a hydrogen subsystem, an air subsystem, a cooling subsystem, and an electronic control system, where the stack is a key component of the fuel cell system, so performance of the stack directly determines performance of the fuel cell system. A dynamic operation process of the fuel cell system will affect performance degradation of the stack, especially in a startup phase. If a starting method is inappropriate, it will directly lead to performance degradation of the stack and even damage the stack. Therefore, a startup control method for the fuel cell system is very important, which will affect the performance, a service life and a failure rate in startup of the stack.

In related technologies, in a starting process of the fuel cell system, hydrogen and air are introduced successively first; and then the fuel cell system starts by quickly loading a current, and a high potential of the stack is avoided by reducing a metering ratio of the air in the starting process. In this way, there is still a situation that the stack is at the high potential for a long time in the starting process of the system, which accelerates corrosion of a stack catalyst, a gas diffusion layer, and a polar plate.

In addition, in reuse of the fuel cell system after long-time placement, the system still starts by a quick loading method. Through this method, whether a state of the stack supports normal startup of the system cannot be judged. If the system cannot start normally, this method will prolong a startup time of the system; and in a severe case, it will cause the system to fail and shut down.

### SUMMARY

In order to solve the above technical problems, the present application provides a startup control method and apparatus for a fuel cell system, an electronic device, and a medium.

According to a first aspect of the present application, a startup control method for a fuel cell system is provided, including:
introducing hydrogen and air into a stack in starting the fuel cell system;
setting a loading current of the fuel cell system as a first current value, detecting a monolithic voltage value of the stack, and comparing the monolithic voltage value with a first voltage value and a second voltage value, wherein the second voltage value is larger than the first voltage value;
in response to the monolithic voltage value being larger than or equal to the first voltage value and smaller than or equal to the second voltage value, starting the fuel cell system;
in response to the monolithic voltage value being larger than the second voltage value, increasing the loading current of the fuel cell system to decrease the monolithic voltage value of the stack, and returning to the step of detecting the monolithic voltage value of the stack;
in response to the monolithic voltage value being smaller than the first voltage value, decreasing the loading current of the fuel cell system to increase the monolithic voltage value of the stack;
detecting the monolithic voltage value of the stack, and judging whether the monolithic voltage value is smaller than the first voltage value;
in response to the monolithic voltage value being smaller than the first voltage value, judging whether the decreased loading current is larger than the second current value, wherein the second current value is smaller than the first current value;
in response to the decreased loading current being larger than the second current value, decreasing the loading current of the fuel cell system to increase the monolithic voltage value of the stack, and returning to the step of detecting the monolithic voltage value of the stack and judging whether the monolithic voltage value is smaller than the first voltage value;
in response to the monolithic voltage value being larger than or equal to the first voltage value, running the fuel cell system for a first preset time period under the decreased loading current, and then returning to the step of setting the loading current of the fuel cell system as the first current value; and
in response to the decreased loading current being smaller than or equal to the second current value and a duration that the monolithic voltage value is smaller than the first voltage value being larger than a second preset time period, stopping startup of the fuel cell system.

Optionally, the introducing hydrogen and air into a stack includes:
introducing the hydrogen into the stack, and detecting a pressure of the hydrogen; and
introducing the air into the stack if the pressure of the hydrogen reaches a preset pressure.

Optionally, the method further includes:
periodically emitting gas on a hydrogen side of the stack before the pressure of the hydrogen reaches the preset pressure.

Optionally, the increasing or decreasing the loading current of the fuel cell system includes:
increasing or decreasing the loading current of the fuel cell system based on a preset current difference.

According to a second aspect of the present application, a startup control apparatus for a fuel cell system is provided, including:
a gas introducing module, configured for introducing hydrogen and air into a stack in starting the fuel cell system;
a loading current setting module, configured for setting a loading current of the fuel cell system as a first current value;
a first monolithic voltage value judging module, configured for detecting a monolithic voltage value of the stack, and comparing the monolithic voltage value with a first voltage value and a second voltage value, wherein the second voltage value is larger than the first voltage value;
a fuel cell system starting module, configured for, in response to the monolithic voltage value being larger than or equal to the first voltage value and smaller than or equal to the second voltage value, starting the fuel cell system;
a loading current increasing module, configured for, in response to the monolithic voltage value being larger than the second voltage value, increasing the loading current of the fuel cell system to decrease the monolithic voltage value of the stack, and returning to the first monolithic voltage value judging module;
a loading current decreasing module, configured for, in response to the monolithic voltage value being smaller than the first voltage value, decreasing the loading current of the fuel cell system to increase the monolithic voltage value of the stack;
a second monolithic voltage value judging module, configured for detecting the monolithic voltage value of the stack, and judging whether the monolithic voltage value is smaller than the first voltage value;
a loading current judging module, configured for, in response to the monolithic voltage value being smaller than the first voltage value, judging whether the decreased loading current is larger than the second current value, wherein the second current value is smaller than the first current value, and wherein

the loading current decreasing module is further configured for, in response to the decreased loading current being larger than the second current value, decreasing the loading current of the fuel cell system to increase the monolithic voltage value of the stack, and returning to the second monolithic voltage value judging module;
a fuel cell system running module, configured for, in response to the monolithic voltage value being larger than or equal to the first voltage value, running the fuel cell system for a first preset time period under the decreased loading current, and then returning to the loading current setting module; and
a startup stopping module, configured for, in response to the decreased loading current being smaller than or equal to the second current value and a duration that the monolithic voltage value is smaller than the first voltage value being larger than a second preset time period, stopping startup of the fuel cell system.

Optionally, the gas introducing module is specifically configured for introducing the hydrogen into the stack, and detecting a pressure of the hydrogen; and introducing the air into the stack if the pressure of the hydrogen reaches a preset pressure.

Optionally, the apparatus further includes:

a hydrogen exhaust emission module, configured for periodically emitting gas on a hydrogen side of the stack before the pressure of the hydrogen reaches the preset pressure.

Optionally, the loading current increasing module is specifically configured for, in response to the monolithic voltage value being larger than the second voltage value, increasing the loading current of the fuel cell system based on a preset current difference; and

the loading current decreasing module is configured for, in response to the monolithic voltage value being smaller than the first voltage value, decreasing the loading current of the fuel cell system based on the preset current difference.

According to a third aspect of the present application, an electronic device is provided, including a processor, where the processor is configured for executing a computer program stored in a memory; and the computer program, when being executed by the processor, implements the method described in the first aspect.

According to a fourth aspect of the present application, a computer-readable storage medium is provided, storing a computer program, where the computer program, when being executed by a processor, implements the method according to the first aspect.

According to a fifth aspect of the present application, a computer program product is provided. When running on a computer, the computer program product enables the computer to perform the method according to the first aspect.

Compared with the prior art, the technical solutions provided by embodiments of the present application have the advantages as follows:

In the starting process of the fuel cell system, the loading current of the fuel cell system is set as the first current value, and the monolithic voltage value of the stack is detected. According to the monolithic voltage value, health of the stack in the starting process is detected to protect the stack. Specifically, if the monolithic voltage value is larger than or equal to the first voltage value and smaller than or equal to the second voltage value, it represents a healthy state of the stack, and the fuel cell system starts. If the monolithic voltage value is larger than the second voltage value, it represents a too high monolithic voltage value of the stack, and thus an unhealthy state of the stack. It can increase the loading current of the fuel cell system one or more times, so that the monolithic voltage value of the stack is smaller than or equal to the second voltage value, which effectively shortens a time when the stack is at the high potential, and avoids generation of the high potential of the stack, thereby solving carbon corrosion of a catalyst, a gas diffusion layer, and a polar plate caused by the high potential of the stack, ensuring performance of the stack, and improving the service life and reliability of the stack. If the monolithic voltage value is smaller than the first voltage value, the loading current of the fuel cell system can be reduced one or more times to increase the monolithic voltage value of the stack. If the monolithic voltage value is larger than or equal to the first voltage value, after the fuel cell system runs for a first preset time period under the decreased loading current, it returns to the step of setting the loading current of the fuel cell system as the first current value. That is, the stack is controlled to run for a period of time under a maximum withstand current, so that the stack can quickly reach the healthy state, and the startup time of the system can be shortened. If the decreased loading current is smaller than or equal to the second current value, and the duration that the monolithic voltage value is smaller than the first voltage value is larger than the second preset time period, it represents problematic performance of the stack, so the startup requirement cannot be met, and the fuel cell system stops starting.

### BRIEF DESCRIPTION OF DRAWINGS

The drawings here are incorporated into the specification and constitute a part of the specification, show the embodiments that comply with the present application, and are used together with the specification for explaining the principles of the present application.

In order to describe the technical solutions in embodiments of the present application or the prior art more clearly, the accompanying drawings required for describing the embodiments or the prior art will be briefly described below. Apparently, a person of ordinary skill in the art can also derive other accompanying drawings from these accompanying drawings without creative efforts.

FIG. 1 is a flowchart of a startup control method for a fuel cell system according to an embodiment of the present application;

FIG. 2 is a schematic structural diagram of a startup control apparatus for a fuel cell system according to an embodiment of the present application; and

FIG. 3 is a schematic structural diagram of an electronic device according to an embodiment of the present application.

### DETAILED DESCRIPTION OF THE EMBODIMENTS

To more clearly understand the objective, features and advantages of the present application, the solution of the present application will be further described below. It is to be noted that the embodiments and features in the embodiments of the present application may be combined with each other without conflict.

Many specific details are set forth in the following description to facilitate a full understanding of the present application, but the present application can also be implemented in other ways different from those described here. Apparently, the embodiments in the specification are only part rather than all of the embodiments of the present application.

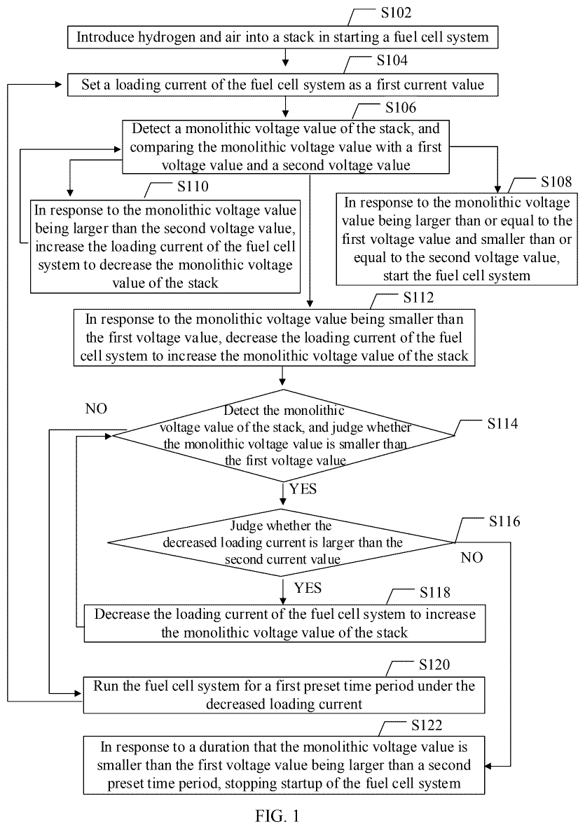

Referring to FIG. 1, it is a flowchart of a startup control method for a fuel cell system according to an embodiment of the present application. The startup control method may include the following steps:

Step S102, introducing hydrogen and air into a stack in starting the fuel cell system.

In starting the fuel cell system, the hydrogen is usually first introduced into an anode of the stack, and then the air is introduced into a cathode. The hydrogen and oxygen undergo an electrochemical reaction under catalysis, and the stack produces a voltage.

In some embodiments, after the hydrogen is introduced into the stack, and a pressure of the hydrogen is detected; and the air is introduced into the stack if the pressure of the hydrogen reaches a preset pressure. In this way, the air on a cathode side can be prevented from penetrating into an anode side.

Optionally, before the pressure of the hydrogen reaches the preset pressure, gas on the hydrogen side of the stack can be periodically emitted to ensure that the air and other gases remaining on the anode side are emitted cleanly in introducing the air into the cathode, so as to avoid a hydrogen-air interface on the anode and accelerate performance degradation of the catalyst.

Step S104, setting a loading current of the fuel cell system as a first current value.

Different first current values may correspond to different scenarios. For example, the first current value may be 0.2 A/cm2, etc.

Step S106, detecting a monolithic voltage value of the stack, and comparing the monolithic voltage value with a first voltage value and a second voltage value.

The first voltage value and the second voltage value are thresholds preset for detecting whether the stack is healthy, and the second voltage value is larger than the first voltage value. The first voltage value and the second voltage value may also change along with a change of the first current value.

Step S108, in response to the monolithic voltage value being larger than or equal to the first voltage value and smaller than or equal to the second voltage value, starting the fuel cell system.

If the monolithic voltage value is larger than or equal to the first voltage value and smaller than or equal to the second voltage value, it represents that the monolithic voltage value is not too high or too low, and the stack is not at a high potential or a low potential, that is, the stack is healthy, and the fuel cell system can start directly.

Step S110, in response to the monolithic voltage value being larger than the second voltage value, increasing the loading current of the fuel cell system to decrease the monolithic voltage value of the stack, and returning to step S106.

If the monolithic voltage value is larger than the second voltage value, it represents the high potential of the stack and thus the unhealthy stack, so the monolithic voltage value of the stack may be decreased by increasing the loading current of the fuel cell system. Optionally, the loading current of the fuel cell system may be increased based on a preset current difference. For example, the preset current difference may be 0.02 A/cm2, etc., and the increased loading current is 0.22 A/cm2. By performing the above steps S106-S110 cyclically, the loading current can be increased many times, and accordingly, the monolithic voltage value of the stack will be gradually decreased. If the monolithic voltage value is smaller than or equal to the second voltage value, it represents the healthy stack, and the fuel cell system starts.

Step S112, in response to the monolithic voltage value being smaller than the first voltage value, decreasing the loading current of the fuel cell system to increase the monolithic voltage value of the stack.

If the monolithic voltage value is smaller than the first voltage value, it represents the low potential of the stack and thus the unhealthy stack, so the monolithic voltage value of the stack may be increased by decreasing the loading current of the fuel cell system. Optionally, the loading current of the fuel cell system may be decreased based on the preset current difference. For example, the preset current difference may be 0.02 A/cm2, etc., and the decreased loading current is 0.18 A/cm2.

Step S114, detecting the monolithic voltage value of the stack, and judging whether the monolithic voltage value is smaller than the first voltage value.

After the loading current of the fuel cell system is decreased, the monolithic voltage value of the stack may be increased. If the monolithic voltage value is still smaller than the first voltage value, step S116 is executed; and if the monolithic voltage value is larger than or equal to the first voltage value, step S120 is executed.

Step S116, judging whether the decreased loading current is larger than the second current value, where the second current value is smaller than the first current value.

If the decreased loading current is larger than the second current value, step S118 is executed; and if the decreased loading current is smaller than or equal to the second current value, it represents a too small decreased loading current, and step S122 is executed.

Step S118, decreasing the loading current of the fuel cell system to increase the monolithic voltage value of the stack, and returning to step S114.

Step S120, after the fuel cell system runs for a first preset time period under the decreased loading current, returning to step S104.

In the embodiments of the present application, although the monolithic voltage value is larger than or equal to the first voltage value, the decreased loading current is smaller than the first current value but is a maximum withstand current for the stack. At this time, the stack is controlled to run for a period of time under the maximum withstand current. This process can increase a humidity in the stack, making the stack quickly reach the healthy state, and shortening a startup time of the fuel cell system. Then, it returns to step S104 to re-execute the above starting process.

Step S122, in response to a duration that the monolithic voltage value is smaller than the first voltage value being larger than a second preset time period, stopping startup of the fuel cell system.

The duration that the monolithic voltage value is smaller than the first voltage value being larger than a second preset time period represents that startup requirements of the fuel cell system cannot be met, and there is problematic performance of the fuel cell system; and then the system can report a fault and stop starting.

In the startup control method for the fuel cell system according to the embodiment of the present application, if the monolithic voltage value is larger than the second voltage value, it represents a too high monolithic voltage value of the stack. It can increase the loading current of the fuel cell system one or more times, so that the monolithic voltage value of the stack is smaller than or equal to the second voltage value, which effectively shortens a time when the stack is at the high potential, and avoids generation of the high potential of the stack, thereby solving carbon corrosion of a catalyst, a gas diffusion layer, and a polar plate caused by the high potential of the stack, ensuring performance of the stack, and improving the service life and reliability of the stack. If the monolithic voltage value is smaller than the first voltage value, the loading current of the fuel cell system can be reduced one or more times to increase the monolithic voltage value of the stack. If the monolithic voltage value is larger than or equal to the first voltage value, after the fuel cell system runs for a first preset time period under the decreased loading current, it returns to the step of setting the loading current of the fuel cell system as the first current value. That is, the stack is controlled to run for a period of time under a maximum withstand current, so that the stack can quickly reach the healthy state, and the startup time of the system can be shortened. If the decreased loading current is smaller than or equal to the second current value, and the duration that the monolithic voltage value is smaller than the first voltage value is larger than the second preset time period, it represents problematic performance of the stack, so the startup requirement cannot be met, and the fuel cell system stops starting.

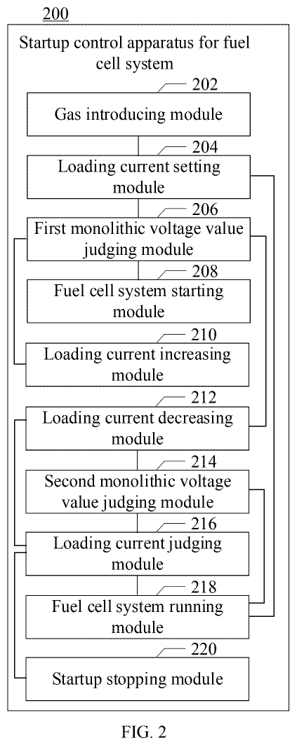

Corresponding to the above method embodiment, an embodiment of the present application further provides a startup control apparatus for a fuel cell system. Referring to FIG. 2, the startup control apparatus 200 for the fuel cell system includes:
a gas introducing module 202, configured for introducing hydrogen and air into a stack in starting the fuel cell system;
a loading current setting module 204, configured for setting a loading current of fuel cell system as a first current value;
a first monolithic voltage value judging module 206, configured for detecting a monolithic voltage value of the stack, and comparing the monolithic voltage value with a first voltage value and a second voltage value, where the second voltage value is larger than the first voltage value;
a fuel cell system starting module 208, configured for, in response to the monolithic voltage value being larger than or equal to the first voltage value and smaller than or equal to the second voltage value, starting the fuel cell system;
a loading current increasing module 210, configured for, in response to the monolithic voltage value being larger than the second voltage value, increasing the loading current of the fuel cell system to decrease the monolithic voltage value of the stack, and returning to the first monolithic voltage value judging module 206;
a loading current decreasing module 212, configured for, in response to the monolithic voltage value being smaller than the first voltage value, decreasing the loading current of the fuel cell system to increase the monolithic voltage value of the stack;
a second monolithic voltage value judging module 214, configured for detecting the monolithic voltage value of the stack, and judging whether the monolithic voltage value is smaller than the first voltage value;
a loading current judging module 216, configured for, in response to the monolithic voltage value being smaller than the first voltage value, judging whether the decreased loading current is larger than the second current value, where the second current value is smaller than the first current value, and where
the loading current decreasing module 212 is further configured for, in response to the decreased loading current being larger than the second current value, decreasing the loading current of the fuel cell system to increase the monolithic voltage value of the stack, and returning to the second monolithic voltage value judging module 214;
a fuel cell system running module 218, configured for, in response to the monolithic voltage value being larger than or equal to the first voltage value, running the fuel cell system for a first preset time period under the decreased loading current, and then returning to the loading current setting module 204; and
a startup stopping module 220, configured for, in response to the decreased loading current being smaller than or equal to the second current value and a duration that the monolithic voltage value is smaller than the first voltage value being larger than a second preset time period, stopping startup of the fuel cell system.

Optionally, the gas introducing module 202 is specifically configured for introducing the hydrogen into the stack, and detecting a pressure of the hydrogen; and introducing the air into the stack if the pressure of the hydrogen reaches a preset pressure.

Optionally, the startup control apparatus 200 for the fuel cell system further includes:
a hydrogen exhaust emission module, configured for periodically emitting gas on a hydrogen side of the stack before the pressure of the hydrogen reaches the preset pressure.

Optionally, the loading current increasing module 210 is specifically configured for, in response to the monolithic voltage value being larger than the second voltage value, increasing the loading current of the fuel cell system based on a preset current difference; and
the loading current decreasing module 212 is configured for, in response to the monolithic voltage value being smaller than the first voltage value, decreasing the loading current of the fuel cell system based on the preset current difference.

The specific details of each module or unit in the above apparatus have been described in detail in the corresponding method, so they are not repeated here.

It is to be noted that although several modules or units of equipment used for action execution are mentioned in detail above, this division is not mandatory. In fact, according to the implementation of the present application, the features and functions of the two or more modules or units described above can be embodied in one module or unit. On the contrary, the features and functions of one module or unit described above can be further divided to be embodied by a plurality of modules or units.

In an exemplary embodiment of the present application, an electronic device is further provided, including: a processor; and a memory for storing processor executable instructions, where the processor is configured to perform the startup control method for the fuel cell system in the exemplary implementation.

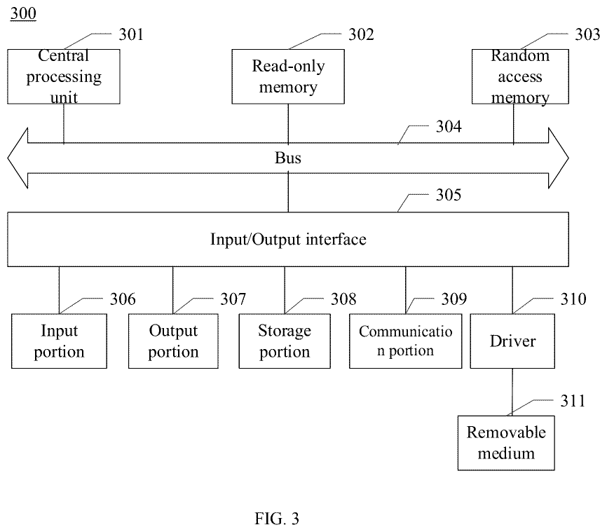

FIG. 3 is a schematic structural diagram of an electronic device according to an embodiment of the present application. It is to be noted that the electronic device 300 shown in FIG. 3 is only an example and should not bring any limitation on the functions and use scope of the embodiments of the present application.

As shown in FIG. 3, the electronic device 300 includes a central processing unit (CPU) 301, which may perform various appropriate actions and processing according to a program stored in a read-only memory (ROM) 302 or a program loaded from a memory cell 308 to a random access memory (RAM) 303. Various programs and data which are required for operations of the system may further be stored in the RAM 303. The central processing unit 301, the ROM 302, and the RAM 303 are connected to each other through a bus 304. An input/output (I/O) interface 305 is also connected to the bus 304.

The following components are connected to the I/O interface 305: an input portion 306 including a keyboard, a mouse, etc.; an output portion 307 including a cathode ray tube (CRT), a liquid crystal display (LCD), a speaker, etc.; a storage portion 308 including a hard disk, etc.; and a communication portion 309 including a network interface card, such as a local area network (LAN) card and a modem. The communication portion 309 performs communication processing through a network such as the Internet. A driver 310 is also connected to the I/O interface 305 as needed. A removable medium 311 such as a magnetic disk, an optical disk, a magneto-optical disk or a semiconductor memory is installed on the driver 310 as needed, so that a computer program read therefrom is installed in the storage portion 308 as needed.

Particularly, according to the embodiment of the present application, the process described below with reference to the flowchart may be realized as a computer software program. For example, the embodiment of the present application includes a computer program product which includes a computer program hosted in a computer-readable medium, and the computer program contains a program code for performing the method shown in the flowchart. In such embodiment, the computer program may be downloaded and installed from a network through the communication portion 309, and/or be installed from the removable medium 311. When the computer program is executed by the central processing unit 301, various functions defined in the apparatus of the present application are executed.

In the embodiment of the present application, a computer-readable storage medium is further provided, storing a computer program, where the computer program, when being executed by a processor, implements the above startup control method for the fuel cell system.

It is to be noted that the computer-readable storage medium shown in the present application may, for example, include, but not limited to, an electronic, magnetic, optical, electromagnetic, infrared, or semiconductor system, apparatus, or device, or any combination of the above. More specific examples of the computer-readable storage medium may include, but not limited to, a portable computer magnetic disk, a hard disk, a random access memory, a read-only memory, an erasable programmable read-only memory (EPROM) or a flash memory, an optical fiber, a portable compact disk read-only memory (CD-ROM), an optical storage device, and a magnetic storage device that are each electrically connected through one or more wires, or any suitable combination of the above. In the present application, the computer-readable storage medium may be any tangible medium that encompasses or stores a program. The program may be used by or in connection with an instruction execution system, apparatus, or device. The program codes encompassed on the computer-readable storage medium may be transmitted via any suitable medium, including, but not limited to: a wireless, wired and optic cable, a radio frequency, etc., or any suitable combination of the above.

In the embodiment of the present application, a computer program product is further provided. When running on a computer, the computer program product enables the computer to perform the startup control method for the fuel cell system.

It should be noted that the relational terms herein such as “first” and “second” are used only to differentiate an entity or operation from another entity or operation, and do not require or imply any actual relationship or sequence between these entities or operations. Furthermore, the terms “include”, “comprise”, or any variants thereof are intended to cover a non-exclusive inclusion, so that a process, method, article, or equipment that includes a series of elements not only includes those elements, but also includes other elements not listed explicitly, or includes inherent elements of the process, method, article, or equipment. In the absence of more limitations, an element defined by “include a . . . ” does not exclude other same elements existing in the process, method, article, or equipment including the elements.

The above is only the specific implementation of the present application, so that those skilled in the art can understand or implement the present application. Various modifications to these embodiments will be readily apparent to those skilled in the art, and the generic principles defined herein may be implemented in other embodiments without departing from the spirit or scope of the present application. Therefore, the present application is not intended to be limited to these embodiments shown herein, but is to be in accordance with the widest scope consistent with the principles and novel features disclosed herein.

What is claimed is:

1. A startup control method for a fuel cell system, comprising:
introducing hydrogen and air into a stack in starting the fuel cell system;
setting a loading current of the fuel cell system as a first current value, detecting a monolithic voltage value of the stack, and comparing the monolithic voltage value with a first voltage value and a second voltage value, wherein the second voltage value is larger than the first voltage value;
in response to the monolithic voltage value being larger than or equal to the first voltage value and smaller than or equal to the second voltage value, starting the fuel cell system;
in response to the monolithic voltage value being larger than the second voltage value, increasing the loading current of the fuel cell system to decrease the monolithic voltage value of the stack, and returning to the step of detecting the monolithic voltage value of the stack;
in response to the monolithic voltage value being smaller than the first voltage value, decreasing the loading current of the fuel cell system to increase the monolithic voltage value of the stack;
detecting the monolithic voltage value of the stack, and judging whether the monolithic voltage value is smaller than the first voltage value;
in response to the monolithic voltage value being smaller than the first voltage value, judging whether the decreased loading current is larger than the second current value, wherein the second current value is smaller than the first current value;
in response to the decreased loading current being larger than the second current value, decreasing the loading current of the fuel cell system to increase the monolithic voltage value of the stack, and returning to the step of detecting the monolithic voltage value of the stack and judging whether the monolithic voltage value is smaller than the first voltage value;
in response to the monolithic voltage value being larger than or equal to the first voltage value, running the fuel cell system for a first preset time period under the decreased loading current, and then returning to the step of setting the loading current of the fuel cell system as the first current value; and
in response to the decreased loading current being smaller than or equal to the second current value and a duration that the monolithic voltage value is smaller than the first voltage value being larger than a second preset time period, stopping startup of the fuel cell system.

2. The method according to claim 1, wherein the introducing hydrogen and air into a stack comprises:
introducing the hydrogen into the stack, and detecting a pressure of the hydrogen; and
introducing the air into the stack if the pressure of the hydrogen reaches a preset pressure.

3. The method according to claim 1, further comprising:
periodically emitting gas on a hydrogen side of the stack before the pressure of the hydrogen reaches the preset pressure.

4. The method according to claim 1, wherein the increasing or decreasing the loading current of the fuel cell system comprises:
increasing or decreasing the loading current of the fuel cell system based on a preset current difference.

5. A startup control apparatus for a fuel cell system, comprising:
a gas introducing module, configured for introducing hydrogen and air into a stack in starting the fuel cell system;
a loading current setting module, configured for setting a loading current of the fuel cell system as a first current value;
a first monolithic voltage value judging module, configured for detecting a monolithic voltage value of the stack, and comparing the monolithic voltage value with a first voltage value and a second voltage value, wherein the second voltage value is larger than the first voltage value;
a fuel cell system starting module, configured for, in response to the monolithic voltage value being larger than or equal to the first voltage value and smaller than or equal to the second voltage value, starting the fuel cell system;
a loading current increasing module, configured for, in response to the monolithic voltage value being larger than the second voltage value, increasing the loading current of the fuel cell system to decrease the monolithic voltage value of the stack, and returning to the first monolithic voltage value judging module;
a loading current decreasing module, configured for, in response to the monolithic voltage value being smaller than the first voltage value, decreasing the loading current of the fuel cell system to increase the monolithic voltage value of the stack;
a second monolithic voltage value judging module, configured for detecting the monolithic voltage value of the stack, and judging whether the monolithic voltage value is smaller than the first voltage value;
a loading current judging module, configured for, in response to the monolithic voltage value being smaller than the first voltage value, judging whether the decreased loading current is larger than the second current value, wherein the second current value is smaller than the first current value, and wherein
the loading current decreasing module is further configured for, in response to the decreased loading current being larger than the second current value, decreasing the loading current of the fuel cell system to increase the monolithic voltage value of the stack, and returning to the second monolithic voltage value judging module;
a fuel cell system running module, configured for, in response to the monolithic voltage value being larger than or equal to the first voltage value, running the fuel cell system for a first preset time period under the decreased loading current, and then returning to the loading current setting module; and
a startup stopping module, configured for, in response to the decreased loading current being smaller than or equal to the second current value and a duration that the monolithic voltage value is smaller than the first voltage value being larger than a second preset time period, stopping startup of the fuel cell system.

6. The apparatus according to claim 5, wherein the gas introducing module is specifically configured for introducing the hydrogen into the stack, and detecting a pressure of the hydrogen; and introducing the air into the stack if the pressure of the hydrogen reaches a preset pressure.

7. The apparatus according to claim 6, further comprising:
a hydrogen exhaust emission module, configured for periodically emitting gas on a hydrogen side of the stack before the pressure of the hydrogen reaches the preset pressure.

8. The apparatus according to claim 5, wherein the loading current increasing module is specifically configured for, in response to the monolithic voltage value being larger than the second voltage value, increasing the loading current of the fuel cell system based on a preset current difference; and
the loading current decreasing module is configured for, in response to the monolithic voltage value being smaller than the first voltage value, decreasing the loading current of the fuel cell system based on the preset current difference.

9. An electronic device, comprising a processor, wherein the processor is configured for executing a computer program stored in a memory, and the computer program, when being executed by the processor, implements the steps of the method according to claim 1.

10. A computer-readable storage medium in which a computer program is stored, wherein the steps of the method according to claim 1 are implemented when the computer program is executed by a processor.
